(19) United States
(12) Patent Application Publication
(10) Pub. No.: US 2011/0209668 A1
(43) Pub. Date: Sep. 1, 2011

(54) Aquarium

(76) Inventors: Günter R. Fuhr, Berlin (DE); Heiko Zimmermann, St. Ingbert (DE)

(21) Appl. No.: 12/679,279

(22) PCT Filed: Aug. 22, 2008
(86) PCT No.: PCT/EP2008/006933

§ 371 Date: May 10, 2011

(30) Foreign Application Priority Data
Sep. 19, 2007 (DE) 10 2007 044 600.6

(51) Int. Cl. A01K 63/00

(52) U.S. Cl. 119/247; 119/269

(57) ABSTRACT

The invention relates to an aquarium with a pressure-tight aquarium tank (7-12), which during operation is filled with a liquid, and with a pressure-resistant rising pipe (1), which opens out into the aquarium tank (7-12) and is intended for producing an increased hydrostatic pressure in the aquarium tank (7-12) by a liquid column located in the rising pipe (1).

The invention relates to an aquarium according to she preamble of the main claim.

For the accommodation and investigation of fish and other marine animals, aquaria are used which essentially comprise a water container which, in operation, is filled with water and which receives the fish or marine animals that are to be accommodated.

A disadvantage of the known aquaria is their lack of suitability for accommodating deep-sea organisms which, in their natural environment in the deep sea are adapted to a high water pressure corresponding to a water column of more than 1000 m and therefore cannot survive in an aquarium, due to the low water pressure prevailing there.

So-called ‘deep sea aquaria’ are known and are used in public zoos for exhibitng fish and other marine animals. The designation of these known aquaria as ‘deep sea aquaria’ is misleading since the water pressure in these aquaria in no way corresponds to the deep-sea pressure, so that they are also not suitable for accommodating deep sea organisms.

In the known aquaria, the water pressure in the water container is generated by the water column standing in the water container, so that the water pressure in the aquarium is limited by the vertical extent of the water container.

The investigation of deep sea organisms has therefore previously been performed with submarine vessels in the deep ocean, although this entails a variety of disadvantages. In the first place, the use of submarine vessels for investigating deep sea organisms is extremely complex. Secondly, the deployment duration of submarine vessels is time-limited so that only correspondingly short investigations of the deep sea organisms can be carried out.

The previously unpublished patent applications DE 10 2006 041 063 and DE 10 2007 027 643 also disclose deep sea aquaria wherein the water container is arranged in the shaft of an underground mine and can therefore extend over a large height difference and this leads to a correspondingly high water pressure at the bottom of the aquarium.

However, a disadvantage of these known deep sea aquaria in underground mines is the danger that, in the event of the aquarium container bursting or leaking, enormous quantities of water emerge and flood the shaft of the mine.

A further disadvantage of deep sea aquaria in underground mines is the fact that the aquarium container almost completely fills the shaft cross-section, so that it is only with difficulty possible that investigation equipment and measuring instruments for scientific work can be accommodated in the shaft.

A further disadvantage is that the maximum possible cross-section of the aquarium is limited by the cross-section of the shafts, which usually have a diameter of between 5 m and 15 m.

Furthermore, the hydrostatic pressure in the known deep sea aquaria in mine shafts increases continuously with depth, so that regions of equal pressure are restricted to a particular depth level in the aquarium. Therefore, there is only a very limited space available for the investigation of marine organisms at a particular hydrostatic pressure.

A further disadvantage of the previously conceived deep sea aquaria in underground mines is the difficulty of controlling the temperature of the water in the aquarium, since any cooling or warming of the water leads to strong vertical water movements in the aquarium container due to the density changes thereby caused.

The use of the previously conceived aquaria has also been limited to underground mines with vertically arranged shafts, since sufficiently pressure-resistant aquarium containers could only be mounted in vertical shafts.

DE 36 42 733 A1 discloses an aquarium in which a raised pressure can be generated in the aquarium in that a compressed air source feeds compressed air into the aquarium. A disadvantage of this known aquarium is therefore that a compressed air source is required in order to increase the pressure in the aquarium.

EP 0 295 322 A1 discloses a method for carrying out chemical processes under pressure. It describes a reaction vessel at the bottom of a mine shaft which can be flushed through with a suspension via a riser pipe and a down pipe. However, this is not an aquarium in the sense of the invention.

Finally, in relation to the prior art, reference is made to DE 100 07 160 A1.

It is therefore an object of the invention to improve the aforementioned conventional aquaria accordingly.

This aim is achieved with an inventive aquarium according to the main claim.

The invention comprises the general technical teaching that the desired hydrostatic pressure in the aquarium is not generated with the column of liquid in the aquarium container, but by means of a riser pipe (e.g. a steel pipe), which extends upwardly from the aquarium container and determines the hydrostatic pressure in the aquarium container by means of the liquid column in the riser pipe.

The invention therefore also provides that the function of pressure generation is separated from the aquarium container and is taken over by the riser pipe. This functional separation offers the advantage that the aquarium container and the riser pipe can be optimised with regard to their functions.

The riser pipe can therefore have a very small cross-section, since the hydrostatic pressure generated in the aquarium by the riser pipe does not depend on the cross-section of the riser pipe, but is determined solely by the height of the fluid column standing in the riser pipe. However, minimising the cross-section of the riser pipe is advantageous in order to reduce the operational risk, since in this way, smaller quantities of liquid emerge in the event of a leak or bursting of the riser pipe.

This functional separation offers the advantage for the aquarium container that the aquarium container no longer need extend over a great height difference. Firstly, the aquarium is much less complex to construct. Secondly, an aquarium with a smaller vertical extent can be more easily temperature-controlled, since temperature-related water movements are less severe, due to the smaller vertical extent.

In a variant of the invention, the aquarium is arranged underground in a mine (e.g. a. coal mine), wherein the riser pipe extends over part of the length thereof underground through the mine, in particular through a shaft and/or a gallery of the mine. This offers the advantage that redundant underground mine workings can be put to a new use and it is not necessary to sink a sufficiently deep shaft by mining methods.

The possibility exists for the riser pipe to extend upwardly above the surface of the earth in order to increase further the hydrostatic pressure in the aquarium. The column of liquid in the riser pipe and therefore the hydrostatic pressure in the aquarium is thus made greater than in the depth of the shaft. For example, the riser pipe can extend above the surface of the earth by a height difference of more than 10 m, 20 m, 50 m, 100 m, 200 m, 500 m, 1000 m, 2000 m or even more than 5000 m. The greater height difference cited above can be realised, for example, in that the riser pipe is guided upwardly above the surface of the earth on a mountain.

Another possibility for additionally increasing the pressure in the aquarium consists in applying an additional ram force to the liquid column in the riser pipe.

Preferably, the riser pipe has a substantially smaller inner cross-section than the shaft and/or the gallery of the underground mine. This advantageously lessens the operational danger, since the mine will be less severely flooded in the event of a burst or a leak in the riser pipe. For example, the riser pipe can have a diameter of less than 50 cm, whereas the shaft has a diameter of 10 m. The whole filling volume of the riser pipe can then be accommodated by a pump well with a volume of 200 m³ if the riser pipe empties completely due to bursting or a leak.

For this reason, the underground mine preferably has an empty hollow space (e.g. a pump well) beneath the aquarium and/or beneath the bottom end of the riser pipe, which is larger than the fill volume of the riser pipe and/or the aquarium, in order to enable the risk-free release of the liquid out of the riser pipe and/or out of the aquarium into the empty hollow space of the underground mine. In the event that the riser pipe bursts, the emerging water is then completely accommodated by the empty hollow space of the mine, so that the space in the mine that is used, and could possibly be used, by operating personnel, does not become flooded.

In another variant of the invention, the riser pipe extends, for at least part of the length thereof, upwardly on a mountain or in a mountain and the aquarium is preferably arranged on the ground or above the ground.

In one embodiment of this variant, the aquarium container is arranged in the immediate vicinity of the mountain, so that the riser pipe can be guided upwardly directly on or in the mountain, in order to generate the desired hydrostatic pressure in the aquarium container.

In another embodiment of this variant, by contrast, the aquarium container is arranged removed from the mountain and is connected via an essentially horizontal or over ground pressure line to the riser pipe, which is guided upwardly on or in the mountain. The pressure line can, for example, bridge a distance between the aquarium container and the riser pipe of at least 100 m, 200 m, 500 m, 1 km, 2 km, 5 km, 10 km, 20 km or even 50 km.

Furthermore, the laying of the riser pipe on a mountain enables the creation of a liquid column in the riser pipe of more than 10 m, 50 m, 100 m, 200 m, 500 m, 1 km, 2 km or even 5 km, wherein the liquid column achievable is essentially limited only by the height of the mountains occurring in the natural world.

The aquarium according to the invention preferably has a shut-off valve which optionally connects the aquarium container to the riser pipe or separates the container from the riser pipe. This offers the advantage that the individual aquarium containers can be separated from the riser pipe in the event of an accident and will therefore not empty out.

It is preferably also provided that the riser pipe is subdivided into successive pipeline sections by a plurality of shut-off valves arranged one behind the other, the sections being separable from one another by the shut-off valves. In the event of a burst or a leak in one of the riser pipe sections, the shut-off valves can be closed, so that the damaged pipeline sections can be isolated and thus only a relatively small quantity of liquid emerges from the riser pipe.

The subdivision of the riser pipe into a plurality of pipeline sections also enables the draining of individual pipeline sections, and simple exchange of the drained pipeline sections.

The aquarium according to the invention also preferably has a drain valve, which is connected to the riser pipe at the lower end thereof in order to be able to drain liquid out of the riser pipe. In the event of a leak or a burst in the upper region of the riser pipe, the drain valve can be opened in order to empty the riser pipe rapidly into a hollow space (e.g. a pump well) situated beneath the drain valve, so that equipment and persons in the shaft at the height of the leak do not become submerged by the liquid emerging from the riser pipe.

Preferably, a pressure pump which is connected to the riser pipe at the lower end thereof is also provided in order to pump the liquid upwardly through the riser pipe.

A suction valve, through which liquid can be drawn out of the riser pipe, can also be connected at the upper end of the riser pipe, so that in the event of a fault, the load on the liquid column in the riser pipe can be relieved. A suction pump which is preferably arranged above ground is therefore preferably connected to the suction valve. The drawing of liquid out of the riser pipe enables targeted pressure reduction so that the reaction of deep sea organisms to the pressure reduction can be investigated.

In one exemplary embodiment of the invention, the aquarium has a plurality of separate aquarium containers into which the riser pipe opens. For example, a plurality of aquarium containers can have the same hydrostatic pressure, for which purpose the aquarium containers are connected to the riser pipe at the same height. However, there is also the possibility that the different aquarium containers are connected to the riser pipe at different heights or depths and therefore have different hydrostatic pressures.

In one exemplary embodiment of the invention, a supply container is also provided, which is filled with liquid during operation and opens into the riser pipe at the upper end thereof in order to fill the riser pipe with liquid (e.g. water). This supply container can be, for example, a natural supply container, such as a mountain lake situated at a great height. Alternatively, the possibility also exists that the supply container is an artificial supply container, such as a water basin or a water tank.

In another exemplary embodiment of the invention, a temperature control apparatus is provided which cools and/or warms the liquid in the aquarium container. With a vertically arranged aquarium container, the possibility exists that a cooling system is arranged at the upper end and/or a heater is arranged at the lower end of the vertical aquarium container, by which means the temperature of the liquid can readily be adjusted.

Furthermore, the aquarium according to the invention can comprise a pressure transfer chamber in order to introduce living beings (e.g. deep sea organisms) or objects into the aquarium container under pressure or to remove them therefrom.

The aquarium container in the aquarium according to the invention can also comprise a drain valve in order to drain liquid from the aquarium container and thereby to reduce the hydrostatic pressure therein.

It has already been mentioned that, in the event of a leak or bursting of the riser pipe, liquid emerges from the riser pipe, which in an arrangement of the riser pipe in a mine shaft, leads thereto that the shaft is partially flooded. In order to reduce this risk of bursting, the riser pipe can be divided into a plurality of partial pipelines, which extend adjacent to one another and separated from one another, so that in the event of a pipeline burst, the quantity of liquid emerging is extremely small and, at worst, leads to minimal flooding of the mine shaft. The individual partial pipelines are preferably grouped together into a pipeline bundle.

The possibility also exists within the context of the invention, that the riser pipe runs horizontally or inclined along part of the length thereof. The riser pipe can also comprise one or more branches.

The invention also provides the possibility that, firstly, the aquarium container and, secondly, the riser pipe are filled with different liquids which are preferably not miscible. For example, the liquid in the riser pipe can have a greater density than the liquid in the aquarium container, so that with a relatively short liquid column in the riser pipe, a relatively great hydrostatic pressure is generated in the aquarium container

Other advantageous embodiments of the invention are defined in the subclaims or will now be described in greater detail together with the description of the preferred exemplary embodiments of the invention, making reference to the drawings, in which:

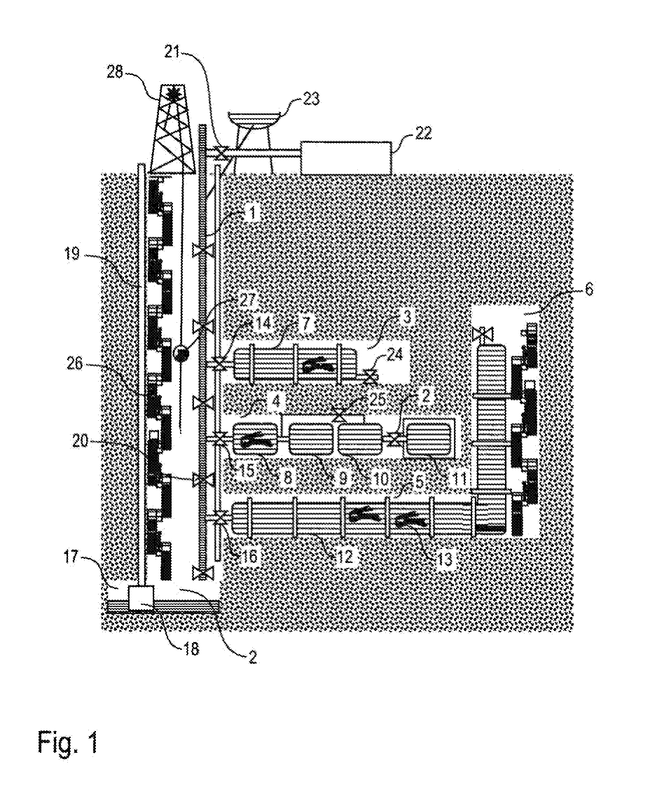

FIG. 1 shows a schematic cross-section through an aquarium according to the invention in an underground mine,

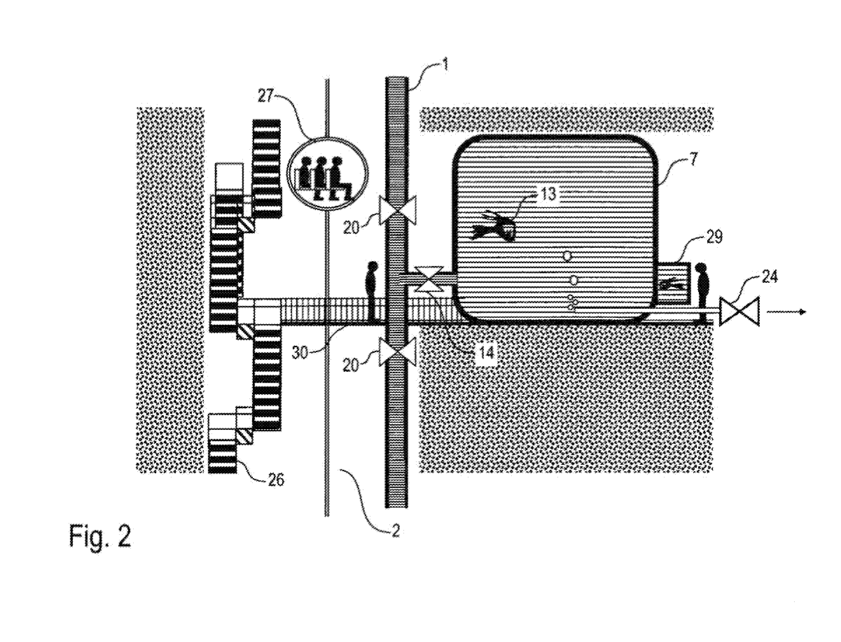

FIG. 2 shows a cross-section through part of an aquarium according to the invention in an underground mine with an aquarium container in a gallery and a riser pipe which runs in a shaft of the mine,

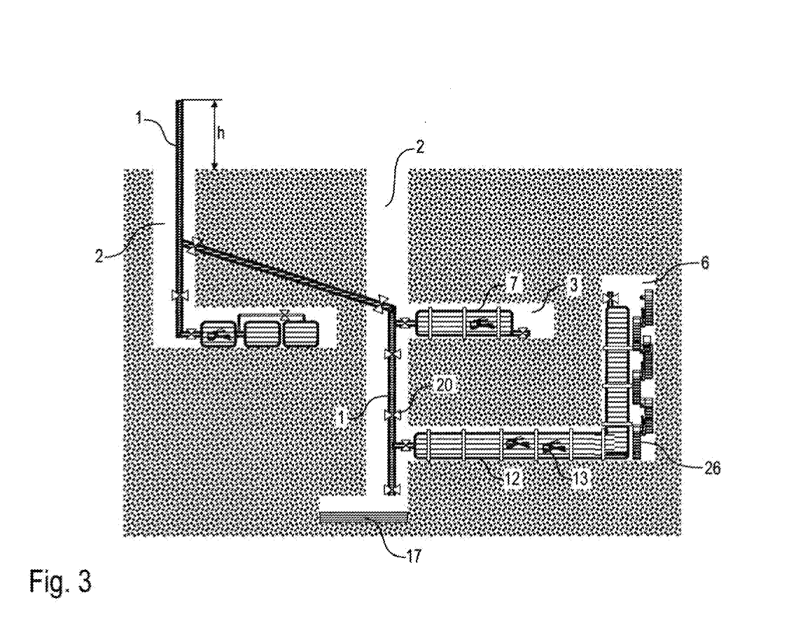

FIG. 3 shows a variant of the above exemplary embodiments of an aquarium according to the invention in an underground mine,

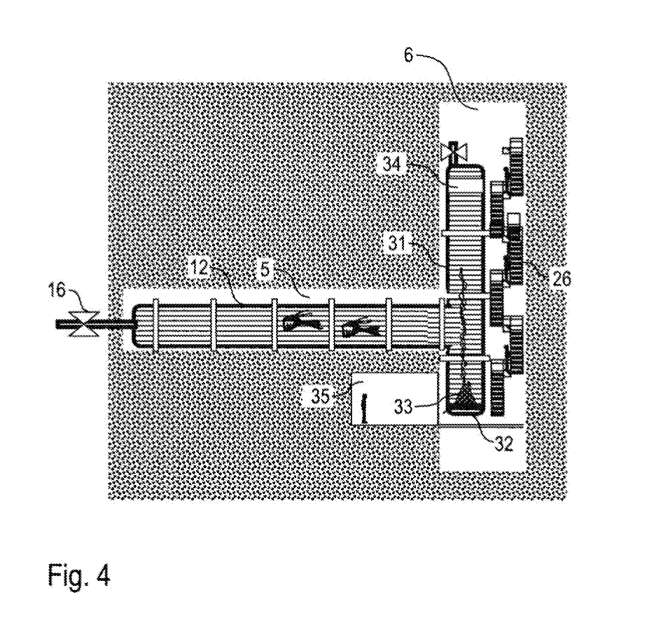

FIG. 4 shows a partial view of an aquarium according to the invention in an underground mine, and

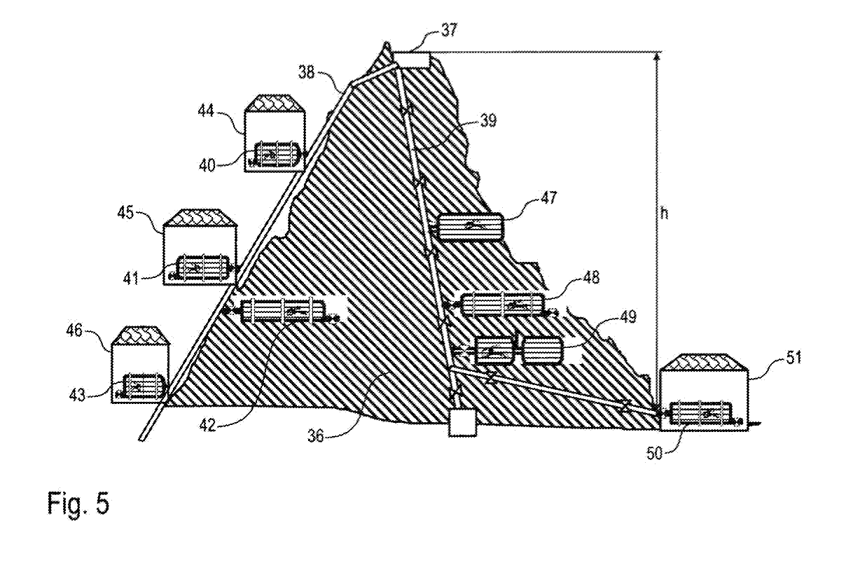

FIG. 5 shows another variant of an aquarium according to the invention, comprising an aquarium container above ground and a riser pipe which extends upwardly on a mountain.

FIG. 1 shows an aquarium according to the invention arranged in an underground mine in order to generate a water pressure corresponding to the pressure of the deep sea.

The water pressure is generated by a riser pipe 1 which is arranged in a shaft 2 of the underground mine, wherein the shaft 2 has a depth of more than 1000 m, so that the water column standing in the riser pipe 1 generates a corresponding water pressure at the bottom of the riser pipe 1.

A plurality of galleries 3, 4, 5 branches off from the shaft 2, wherein a blind shaft 6 extends upwardly from the gallery 5. Arranged in the galleries 3, 4, 5 and in the blind shaft 6 are aquarium containers 7, 8, 9, 10, 11 and 12 which can serve, for example, for the accommodation and investigation of deep sea organisms 13.

The aquarium containers 7, 8 and 12 are each connected via a shut-off valve 14, 15, 16 to the riser pipe 1 so that the liquid column standing in the riser pipe 1 above the respective shut-off valve 14, 15 determines the pressure in the water container 7, 8 and 12 when the respective shut-off valve 14, 15 or 16 is open.

The riser pipe 1 has a substantially smaller internal cross-section than the shaft 2 so that in the event of a leak or a burst in the riser pipe 1, only relatively small quantities of water emerge from the riser pipe 1 and these can easily be fully accommodated by a pump well 17 at the lower end of the shaft 2.

Also situated in the pump well 17 is a pressure pump 18 which is able to pump the water situated in the pump well 17 upwardly out of the shaft 2 through a pressure pipeline 19.

The operating risks of the aquarium according to the invention are further reduced by a plurality of shut-off valves 20, wherein the shut-off valves 20 divide the riser pipe 1 into a plurality of pipeline sections arranged one above the other. In the event of a pipeline burst or a leak in one of the pipeline sections of the riser pipe 1, this pipeline section can be isolated from the remainder of the pipeline sections in that the adjacent shut-off valves 20 are closed. By this means, the maximum quantity of water emerging in the event of a leak can be further reduced.

A suction pump 22 is arranged at the upper end of the riser pipe 1, attached via a suction valve 21 to the riser pipe 1, wherein, in the opened condition of the suction valve 21, the suction pump 22 is able to draw water out of the riser pipe 1 in order to lighten the water column standing in the riser pipe 1 and thereby to reduce the pressure.

A supply container 23 which is filled with water is also arranged above ground and is connected via a pipeline to the riser pipe 1 in order to fill the riser pipe 1 with water.

The aquarium container 7 in the shaft 3 also has a drain valve 24 via which water can be let out of the aquarium container 7 in order to reduce the pressure in the aquarium container 7. However, the aquarium containers 8-11 in the shaft 4 are separated from one another, wherein the two water containers 8 and 9 are connected to one another via a pipeline. The aquarium containers 8 and 9, on the one side, and the aquarium container 10, on the other side, are connected to one another via a pipeline and a shut-off valve 25. Furthermore, the two aquarium containers 10 and 11 are connected to one another via a pipeline and a shut-off valve 26.

Situated in the shaft 2 beside the riser pipe 1 are stairs 26 and a lift with a cabin 27 which can be raised or lowered by means of a winding tower 28.

FIG. 2 shows a partial view of an aquarium according to the invention in an underground mine, wherein this exemplary embodiment partially corresponds to the exemplary embodiment described above and shown in FIG. 1, so that to avoid repetition, reference is made to the above description and the same reference signs are used for corresponding details.

A special feature of this exemplary embodiment consists therein that the aquarium container 7 has a pressure transfer chamber 29 by means of which animals, feed or instruments can be introduced into or removed from the interior of the aquarium container 7 without loss of pressure.

This drawing also shows a platform 30 on which scientists, service personnel or visitors can walk.

The exemplary embodiment according to FIG. 3 largely corresponds to the exemplary embodiments described above, so that to avoid repetition, reference is made to the above descriptions and the same reference signs are used for corresponding details.

A special feature of this exemplary embodiment consists therein that the riser pipe 1 does not only extend from the bottom to the surface of the earth, but covers a height difference h above the surface of the earth, so that the water column standing in the riser pipe 1 and therefore the maximum pressure that can be created is additionally increased.

A further special feature of this exemplary embodiment consists therein that the riser pipe 1 branches and, after branching, extends inclined through the earth.

The exemplary embodiment according to FIG. 4 also largely corresponds to the exemplary embodiments described above, so that to avoid repetition, reference is made to the above description and the same reference signs are used for corresponding details.

A special feature of this exemplary embodiment consists therein that the aquarium container 12 comprises a vertically oriented aquarium container section 31 in the vertically extending blind shaft 6. A heater 32 which heats a hot spring 33 is arranged at the lower end of the aquarium container section 31. Arranged at the upper end of the aquarium container section 31 is a cooling system 34. Together with the cooling system 34, the heater 32 enables effective adjustment of the temperature in the aquarium container section 31.

A further special feature of this exemplary embodiment consists therein that, situated laterally adjacent to the heater 32, is a workroom 35 from where the system can be observed and controlled in a climate-controlled environment.

FIG. 5 shows another variant of an aquarium according to the invention, which is not arranged underground but above ground.

In this case, a supply container 37 which is filled with water is arranged at the summit of a mountain 36, wherein said supply container can he a natural mountain lake or an artificial water basin.

The supply container 37 feeds two riser pipes 38, 39 with water, wherein the riser pipe 38 extends over the earth on the flank of the mountain 36, whereas the other riser pipe 39 extends through the rock within the mountain 36.

The aquarium containers 40, 41, 42, 43 are connected to the riser pipe 38 at various heights, wherein the water column standing in the riser pipe 38 generates a corresponding water pressure in the aquarium containers 40, 41, 42 and 43.

The aquarium containers 40, 41 and 43 are accommodated above ground in huts 44, 45, 46, whereas the aquarium container 42 is accommodated in a cavern within the mountain 36.

Aquarium containers 47, 48, 49 and 50 are also connected to the other riser pipe 39, so that the liquid column 39 standing in the riser pipe 39 generates a corresponding water pressure in the aquarium containers 47-50. The aquarium containers 47-49 are arranged in caverns in the mountain 36, whereas the aquarium container 50 is also accommodated in a but 51.

The invention is not restricted to the above described preferred embodiments. Rather a plurality of variants and derivations is possible and these also make use of the inventive concept and therefore fall within the protective scope.

### SIGNS

1 Riser pipe
2 Shaft
3-5 Gallery
6 Blind shaft
7-12 Aquarium container
13 Deep sea organisms
14-16 Shut-off valves
17 Pump well
18 Pressure pump
19 Pressure line
20 Shut-off valve
21 Suction valve
22 Suction pump
23 Supply container
24 Drain valve
25 Shut-off valve
26 Stairs
27 Cabin
28 Winding tower
29 Pressure transfer chamber
30 Platform
31 Aquarium container section
32 Heater
33 Hot spring
34 Cooling system
35 Workroom
36. Mountain
37 Supply container
38, 39 Riser nines
40-43 Aquarium containers
44-46 Huts
47-50 Aquarium containers
51 Hut

1. An aquarium comprising a pressure-resistant aquarium container, which in operation is filled with liquid, further comprising a pressure-resistant riser pipe which opens into the aquarium container in order to create a raised hydrostatic pressure in the aquarium container by means of a liquid column standing in the riser pipe

2. The aquarium according to claim 1, wherein
(a) the aquarium container is arranged underground in an underground mine, and
(b) the riser pipe extends over at least part of the length thereof underground through the underground mine, in particular through a cavity of the underground mine

3. The aquarium according to claim 2, wherein the riser pipe extends upwardly above the surface of the earth in order to further increase the hydrostatic pressure in the aquarium container.

4. The aquarium according to claim 3, wherein the riser pipe extends above the surface of the earth by a height difference (h) of more than a minimum value, wherein the minimum value is selected from a group consisting of 10 m, 20 m, 50 m, 100 m, 200 m, 500 m, 1000 m, 2000 m and 5000 m.

5. The aquarium according to claim 2, wherein the riser pipe has a substantially smaller inner cross-section than the shaft.

6. The aquarium according to claim 2, wherein the underground mine preferably has a hollow space beneath the aquarium container, which is larger than the fill volume of the riser pipe and/or the aquarium container in order to enable the risk-free release of the liquid out of the riser pipe and out of the aquarium container

7. The aquarium according to claim 1, wherein the riser pipe extends, for at least part of the length thereof, upwardly on a mountain.

8. The aquarium according to claim 7, wherein
the aquarium container is arranged on the mountain.

9. The aquarium according to claim 8, wherein the pressure line bridges a distance between the mountain and the aquarium container larger than a minimum value which is selected from a group consisting of 100 m, 200 m, 500 m, 1 km, 2 km, 5 km, 10 km, 20 km and 50 km.

10. The aquarium according to claim 1, wherein the liquid column in the riser pipe has a height of more than a minimum value, wherein the minimum value is selected from a group consisting of 10 m, 50 m, 100 m, 200 m, 500 m, 1 km, 2 km and 5 km.

11. The aquarium according to claim 1, further comprising at least one shut-off valve which optionally connects the aquarium container to the riser pipe or separates the aquarium container from the riser pipe.

12. The aquarium according to claim 1, wherein the riser pipe is subdivided into successive pipeline sections by a plurality of shut-off valves arranged one behind the other.

13. The aquarium according to claim 1, further comprising a drain valve which is connected to the riser pipe at the lower end thereof in order to be able to drain liquid out of the riser pipe.

14. The aquarium according to claim 1, further comprising a pressure pump which is connected to the riser pipe at the lower end thereof, in order to pump liquid upwardly through the riser pipe.

15. The aquarium according to claim 1, further comprising a suction valve, which is connected to the riser pipe at the upper end thereof, in order to draw liquid out of the riser pipe.

16. The aquarium according to claim 15, further comprising a suction pump which is connected to the suction valve, in order to draw liquid out of the riser pipe.

17. The aquarium according to claim 1, further comprising a plurality of separate aquarium containers into which the riser pipe opens.

18. The aquarium according to claim 17, wherein the aquarium containers are arranged at different heights.

19. The aquarium according to claim 1, further comprising a supply container which opens into the riser pipe at the upper end of the riser pipe.

20. The aquarium according to claim 19, wherein the supply container is selected from a group consisting of a mountain lake and a water basin on a mountain.

21. The aquarium according to one claim 1, further comprising a temperature control apparatus which tempers the liquid in the aquarium container.

22. The aquarium according to claim 1, further comprising a pressure transfer chamber for introducing objects into the aquarium container which is under pressure.

23. The aquarium according to claim 1, further comprising a drain valve, via which the liquid can be drained out of the aquarium container.

24. The aquarium according to claim 1, further comprising a vertically extending aquarium container section, wherein a cooling system is arranged at the upper end of the vertical aquarium container section.

25. The aquarium according to claim 1, wherein
(a) the riser pipe comprises a pipeline bundle made from a plurality of partial pipelines extending adjacent to one another and separate from one another, in order to reduce the quantity of liquid emerging in the event of a pipeline breakage;
(b) the riser pipe extends horizontally along part of the length thereof;
(c) the riser pipe extends inclined along part of the length thereof; and
(d) the riser pipe comprises at least one branch.

26. The aquarium according to claim 1, wherein the aquarium container and the riser pipe are filled with different, immiscible liquids.

27. The aquarium according to claim 26, wherein the liquid in the riser pipe has a greater density than the liquid in the aquarium container.

28. The aquarium according to claim 2, wherein the cavity is a shaft.

29. The aquarium according to claim 2, wherein the cavity is a gallery.

30. The aquarium according to claim 2, wherein the riser pipe has a substantially smaller inner cross-section than the gallery of the underground mine.

31. The aquarium according to claim 1, wherein the riser pipe extends, for at least part of the length thereof, upwardly in a mountain.

32. The aquarium according to claim 10, wherein the aquarium container is arranged remote from the mountain and is connected to the riser pipe via a pressure line.

33. The aquarium according to claim 1, further comprising a vertically extending aquarium container section, wherein a heater is arranged at the lower end of the vertical aquarium container section.
